(19) United States
(12) Patent Application Publication
(10) Pub. No.: US 2011/0182960 A1
(43) Pub. Date: Jul. 28, 2011

(54) Antimicrobial Coating

(76) Inventors: Elisabeth Marianna Wilhelmina Maria Van Dongen, Tilburg (NL); Sebastianus Gerardus Kluijtmans, Holland (NL)

(21) Appl. No.: 13/121,512

(22) PCT Filed: Sep. 29, 2009
(86) PCT No.: PCT/GB2009/051272

§ 371 Date: Mar. 29, 2011

(30) Foreign Application Priority Data
Oct. 2, 2008 (EP) 08165722.3

(51) Int. Cl. A01N 25/00; A01N 43/16; A01P 1/00; B05D 5/00; B05D 3/02; B05D 1/36

(52) U.S. Cl. 424/411; 514/774; 514/25; 427/2.1

(57) ABSTRACT

The invention relates to methods for applying coatings comprising recombinant gelatin and an antimicrobial agent to a surface. In particular, the invention is concerned with methods for coating medical devices. The invention is also concerned with coated surfaces and medical devises, and compositions comprising gelatin and an antimicrobial agent.

### FIELD OF INVENTION

This invention related to methods for applying coatings comprising recombinant gelatin and an antimicrobial agent to a surface. In particular, the invention is concerned with methods for coating medical devices. The invention is also concerned with coated surfaces and medical devices, and compositions comprising gelatin and an antimicrobial agent.

### BACKGROUND OF THE INVENTION

Bacteria are present on the surface of the skin and throughout the bodies of humans and animals. Not all of these bacteria are harmful, but medical instruments must be sterilized to prevent harmful bacteria from infecting wounds or incisions. Sterilization before use is sufficient for short-term use medical instruments, i.e., those that remain in contact with the body for less than forty-eight hours, because those medical instruments are generally removed before significant bacterial growth can occur.

Medical devices that remain in the body of humans or animals for longer periods of time create an ideal attachment surface and growth area for bacteria. Furthermore, introduction of medical devices into the body allows bacteria to bypass the subcutaneous layers. The resulting infections often are harmful and can even be deadly.

Current medical devices such as catheters can only remain inside the body for a limited amount of time before they must be removed and replaced with a sterilized device. Removal and replacement is often painful for the patient. Moreover the removal and replacement of these longer-term devices can be complicated and raise the costs of medical care. Various methods have been proposed for the development of coatings for medical devices that have antimicrobial properties. One approach is the development of coatings that elute antimicrobial agents. Coating material suitable for such coatings are proteinaceous coating materials comprising gelatin or collagen. Coatings comprising gelatins and collagens are commonly heated at temperatures higher than 50° C. in order to achieve sufficient fluidity of the gelling proteins. However, some of the most effective antimicrobial compounds are sensitive to high temperatures (e.g., above 50° C.), which makes their use for coatings in combination with gelatins and collagens difficult. Such high temperatures have a detrimental effect on temperature sensitive antibiotics, for example, beta-lactam antibiotics. This results in antimicrobial coatings having a limited amount of antimicrobial compounds and a limited effectiveness. It is a goal of the present invention to provide a method of applying a proteinaceous coating material so that it has prolonged antimicrobial activity and allows incorporation of antimicrobial compounds into gelatin or collagen coatings without reduction of their activity.

### SUMMARY OF THE INVENTION

This invention related to methods for applying coatings comprising recombinant gelatin and an antimicrobial agent to a surface. In particular, the invention is concerned with methods for coating medical devices. The inventors surprisingly found that a coating comprising recombinant gelatin reduces the adherence and colonisation of a medical device surface by known microbial pathogens. Furthermore, in contrast with the prior art, the use of non-gelling recombinant gelatin allows the use of relatively low temperatures during the coating procedure, which is beneficial to the incorporation of antibiotics, in particular temperature sensitive antibiotics, to enhance the anti-microbial properties of the coating.

### General Definitions

Unless defined otherwise, all technical and scientific terms used herein have the meanings as commonly understood by one of ordinary skill in the art to which the invention belongs.

“A medical device” as is used herein means a device or product for human body reconstruction and/or an object which is implanted in the body to control drug release. This term includes absorbable devices and products.

The terms “antimicrobial” and “antibiotic” are used interchangeably and refer to any natural, synthetic, and semi-synthetic compound that has been identified as possessing antibacterial, antifungal, antiviral, or antiparasitic activity. In the present invention, such activity means decreasing the chance of contamination and subsequent infection of the medical device with micro-organisms upon prolonged use in vivo. This can mean for example, but is not limited to, limiting, preventing or delaying attachment of micro-organisms to the medical device and/or killing micro-organisms and/or limiting, preventing or inhibiting the growth of micro-organisms. The term “antimicrobial agent” may refer to a single antimicrobial or to a mixture of antimicrobials.

“Proteinaceous coating material” as used herein is a composition comprising a protein.

The terms “protein” or “polypeptide” or “peptide” are used interchangeably and refer to molecules consisting of a chain of amino acids, without reference to a specific mode of action, size, three-dimensional structure or origin.

“Gelatin” as used herein refers to any gelatin, whether extracted by traditional methods or recombinant or biosynthetic in origin, or to any molecule containing at least one collagenous domain (Gly-X-Y region). Gelatin is currently obtained by extraction from collagen derived from animal (e.g., bovine, porcine, rodent, chicken, equine, and piscine) sources, e.g., bones and tissues. The term encompasses both the composition of more than one polypeptide included in a gelatin product, as well as an individual polypeptide contributing to the gelatin material. Thus, the term recombinant gelatin as used in reference to the present invention encompasses both recombinant gelatin material comprising gelatin polypeptides, as well as an individual gelatin polypeptide.

Polypeptides from which gelatin can be derived are polypeptides such as collagens, procollagens, and other polypeptides having at least one collagenous domain (Gly-X-Y region). Such a polypeptide could include a single collagen chain, or a collagen homotrimer or heterotrimer, or any fragments, derivatives, oligomers, polymers, or subunits thereof. The term specifically contemplates engineered sequences not found in nature, such as altered collagen sequences, e.g. a sequence that is altered, through deletions, additions, substitutions, or other changes, from a naturally occurring collagen sequence. Such sequences may be obtained from suitable altered collagen polynucleotide constructs, etc.

Non-gelling gelatins as used herein are gelatins with Bloom strength of lower than 50 g and preferably gelatins with a Bloom strength below 10 g.

“Bloom strength” as used herein is a measurement of the strength of a gel formed by a 6.67% solution (w/v) of gelatin in a constant temperature bath (10° C.) over 17 hours. A standard Texture Analyzer is used to measure the weight in grams required to depress a standard 0.5 inch in diameter AOAC (Association of Official Agricultural Chemists) plunger 4 millimetres into the gel. If the weight in grams required for depression of the plunger is 200 grams, the particular gelatin has a Bloom value of 200 g. (See, e.g., United States Pharmacopoeia and Official Methods of Analysis of AOAC International, 17th edition, Volume II).

A “thermolabile” compound as used herein is subject to destruction, decomposition, or great change by moderate heating. Thermolabile antimicrobial compounds generally have a reduced stability at a certain temperature in comparison to other antimicrobial compounds.

A “cross-linking agent” as described herein refers to a composition comprising a cross-linker. “Cross-linker” as used herein refers to a reactive chemical compound that is able to introduce covalent intra- and extra-molecular bridges in organic molecules.

The term “comprising” is to be interpreted as specifying the presence of the stated parts, steps or components, but does not exclude the presence of one or more additional parts, steps or components.

In addition, reference to an element by the indefinite article “a” or “an” does not exclude the possibility that more than one of the element is present, unless the context clearly requires that there be one and only one of the elements. The indefinite article “a” or “an” thus usually means “at least one”.

### DETAILED DESCRIPTION OF THE INVENTION

The present invention provides a method for applying a coating, comprising recombinant gelatin and an antimicrobial agent, to a surface comprising the steps of:
a) mixing the recombinant gelatin and the antimicrobial agent at a temperature of between 0° C. and 40° C. to obtain a mixture; and
b) crosslinking the mixture at a temperature of between 0° C. and 40° C.

In an embodiment a surface is coated and/or crosslinked with the coating composition at a temperature below 25° C., preferably below 20° C., more preferably below 10° C., and optionally below 5° C. However, the coating should be applied and/or crosslinked at a temperature above 0° C.

In another embodiment a surface is coated and/or crosslinked with the coating composition above 5° C., and particularly above 10° C.

Preferably the coating is applied onto the surface either in-between steps a) and b), or after step b). In the latter case, the coating is to be applied prior to curing of the coating. Step b) may be performed by addition of one or more chemical crosslinking agent. Alternatively, a photo-initiator of crosslinking may be mixed with the recombinant gelatin and the antimicrobial agent in step a), followed by application of UV or visible light irradiation to crosslink the mixture thus obtained. Alternatively, the coating according to the present invention may be achieved by coating the surface with the recombinant gelatin, followed by contacting the surface with a solution comprising the antimicrobial agent, whereby the antimicrobial agent is incorporated in the recombinant gelatin.

In a preferred embodiment, the coating is applied to the surface of a medical device. Examples of medical devices that may be coated according to the invention include, but are not limited to, a stent, stent graft, anastomotic connector, synthetic patch, lead, electrode, needle, guide wire, catheter, sensor, surgical instrument, angioplasty balloon, wound drain, shunt, tubing, infusion sleeve, urethral insert, pellet, implant, blood oxygenator, pump, vascular graft, vascular access port, heart valve, annuloplasty ring, suture, surgical clip, surgical staple, pacemaker, implantable defibrillator, neurostimulator, orthopaedic device, cerebrospinal fluid shunt, implantable drug pump, spinal cage, artificial disc, replacement device for nucleus pulposus, ear tube, intraocular lens and any tubing used in minimally invasive surgery. Articles that are particularly suited to be used in the present invention include medical devices or components such as catheters, guide wires, stents, syringes, metal and plastic implants, contact lenses, medical tubing, and partly extracorporeal devices. It is particularly preferred that the coating is applied to the surface of a medical device selected from the group consisting of a vascular stent, a surgical implant and a catheter.

The use of recombinant gelatins in the coating compositions used in the methods of the present invention provides medical benefit compared to conventionally produced gelatins from animal sources. The inability to completely characterize, purify, or reproduce the animal-sourced gelatin mixtures used currently is of ongoing concern in the pharmaceutical and medical communities. Conventional gelatins suffer from safety issues, such as concern over potential immunogenic, e.g., antigenic and allergenic responses, as well as concerns with respect to bacterial contamination and endotoxin loads resulting from the extraction and purification processes. Recombinantly produced gelatins provide a solution to these safety concerns. Moreover the recombinant technology allows the design of gelatin-like proteins with altered characteristics, for example, but not limited to, low immunogenicity, improved cell attachment and/or controlled biodegradability. A further benefit is that recombinantly produced gelatin is more uniform in structure and size, which enhances the uniformity of the coating obtained.

EP 0926543, EP 1014176 and WO 01/34646, and also EP 0926543 and EP 1014176, specifically the examples section, describe recombinant gelatins and their production methods, using methylotrophic yeasts, in particular Picha pastoris. WO 01/34646 discloses the use of recombinant gelatin as a coating.

The recombinant gelatin may be one type of recombinant gelatin or may be a mixture of two or more types of recombinant gelatin. Similarly, the coating may comprise one type of antimicrobial agent or may comprise two or more types of antimicrobial agents.

In a beneficial embodiment the recombinant gelatin comprises non-gelling recombinant gelatin. Such non-gelling recombinant gelatin is advantageous in that it is known to require less high temperatures in order to achieve sufficient fluidity for coating applications. This allows incorporation of temperature-sensitive antimicrobial agents without loss of their activity and/or stability upon preparation of the coating and its application to a surface.

In an embodiment of the present invention the coating comprises recombinant gelatin that is non-hydroxylated gelatin. In a further embodiment the coating comprises recombinant gelatin that is substantially free from helix formation. Such non-hydroxylated recombinant gelatin and recombinant gelatin substantially free from helix formation contain less tertiary structure than natural gelatin and as such require less high temperatures to achieve sufficient fluidity for coating applications, allowing incorporation of temperature-sensitive antimicrobial agents as discussed above.

A particular benefit of the proteinaceous coating material comprising recombinant gelatins is that it reduces the ability of micro-organisms to attach and colonize the surface of the medical devices, enhancing the antimicrobial property of the coating. The coating is particularly effective against, but not limited to, attachment of known pathogens such as bacteria of the genus Staphylococcus and the genus Pseudomonas more specifically Staphylococcus epidermidis and Pseudomonas aeruginosa.

The antimicrobial agent may be a thermolabile antimicrobial agent, such as, phosphoramidon, blasticidin S, chymostatin, antipain, thermolabile aminoglycosides such as, but not limited to kasugamycin, tobramycin, amikacin, lividomycin A, dihydrostreptomycin, minosaminomycin, beta-lactam antibiotics such as, but not limited to the bicyclic beta-lactam thiazolidines, penems such as but not limited to, thienamycin, imipenem, sulopenem, ritipenem, faropenem and cefmetazole. Preferably the thermolabile antimicrobial agent is a thermolabile aminoglycoside or a thermolabile beta-lactam antibiotic.

The coating of the invention can be applied to a surface, such as that of a medical device, using different methods. The coating material can for example, but not limited to, be sprayed on the medical device. In another embodiment the proteinaceous coating material of the invention is a solution in which the medical device is submerged, which also can be referred to as dip-coating. Other methods of application are wash, vapour deposition, brush, roller, curtain, spin coating and other methods known in the art.

In one embodiment the coating material further comprises also a cross-linking agent. In another embodiment the medical devices received a pre-treatment, which impregnates the devices with a cross-linking agent. Suitable cross-linking agents are known in the art. They include chemical cross-linkers selected from aldehyde compounds such as formaldehyde and glutaraldehyde, carbodiimide, di-aldehyde di-isocyanate, epoxides, ketone compounds such as diacetyl and chloropentanedion, bis(2-chloroethylurea), 2-hydroxy-4,6-dichloro-1,3,5-triazine, reactive halogen-containing compounds disclosed in U.S. Pat. No. 3,288,775, carbamoyl pyridinium compounds in which the pyridine ring carries a sulphate or an alkyl sulphate group disclosed in U.S. Pat. No. 4,063,952 and U.S. Pat. No. 5,529,892, divinylsulfones, and the like and S-triazine derivatives such as 2-hydroxy-4,6-dichloro-s-triazine. In a useful embodiment the cross-linking agent is 1-ethyl-3-(3-dimethylaminopropyl)carbodiimide hydrochloride (EDC).

In an embodiment the recombinant gelatin is chemically modified with a cross-linkable group, so that only the gelatin crosslinks and not the antimicrobial agent. This is beneficial to preserve the activity and/or stability of the antimicrobial agent. One skilled in the art is well aware of groups that may be suitable for crosslinking purposes. The cross-linkable group may e.g. be selected from, but is not limited to, epoxy compounds, oxetane derivatives, lactone derivatives, oxazoline derivatives, cyclic siloxanes, or ethenically unsaturated compounds such as acrylates, methacrylates, polyene-polythiols, vinylethers, vinylamides, vinylamines, allyl ethers, allylesters, allylamines, maleic acid derivatives, itacoic acid derivatives, polybutadienes and styrenes. Preferably as the cross-linkable group (meth)acrylates are used, such as alkyl-(meth)acrylates, polyester-(meth)acrylates, urethane-(meth)acrylates, polyether-(meth)acrylates, epoxy-(meth)acrylates, polybutadiene-(meth)acrylates, silicone-(meth)acrylates, melamine-(meth)acrylates, phosphazene-(meth)acrylates, (meth)acrylamides and combinations thereof because of their high reactivity. Even more preferably said cross-linkable group is a methacrylate and hence the invention also provides methacrylated (recombinant) gelatin. Such a methacrylated (recombinant) gelatin is very useful in the preparation of a controlled release composition. Generally, the cross-linkable groups (for example methacrylate) are coupled to the (recombinant) gelatin and cross-linking is obtained by redox polymerisation (for example by subjection to a chemical initiator such as the combination potassium peroxodisulfate (KPS)/N,N,N′,N′-tetramethylethyenediamine (TEMED)) or by radical polymerisation in the presence of an initiator for instance by thermal reaction of by radiation such as UV-light).

Photo-initiators of cross-linking may be used. They can be mixed with the recombinant gelatin. Photo-initiators are usually required when the mixture is cured by UV or visible light radiation. Suitable photo-initiators are well known in the art. They include radical type, cation type or anion type photo-initiators.

Non-limiting examples of radical type I photo-initiators are a-hydroxyalkylketones, such as 2-hydroxy-1-[4-(2-hydroxyethoxy)phenyl]-2-methyl-1-propanone (Irgacure™ 2959: Ciba), 1-hydroxy-cyclohexyl-phenylketone (Irgacure™ 184: Ciba), 2-hydroxy-2-methyl-1-phenyl-1-propanone (Sarcure™ SR1173: Sartomer), oligo[2-hydroxy-2-methyl-1-{4-(1-methylvinyl)phenyl}propanone] (Sarcure™ SR1130: Sartomer), 2-hydroxy-2-methyl-1-(4-tert-butyl-)phenylpropan-1-one, 2-hydroxy-[4′-(2-hydroxypropoxy)phenyl]-2-methylpropan-1-one, 1-(4-Isopropylphenyl)-2-hydroxy-2-methyl-propanone (Darcure™ 1116: Ciba); a aminoalkylphenones such as 2-benzyl-2-(dimethylamino)-4′-morpholinobutyrophenone (Irgacure™ 369: Ciba), 2-methyl-4′-(methylthio)-2-morpholinopropiophenone (Irgacure™ 907: Ciba); a,a dialkoxyacetophenones such as a,a dimethoxy-a-phenylacetophenone (Irgacure™ 651: Ciba), 2,2-diethyoxy-1,2-diphenylethanone (Uvatone™ 8302: Upjohn), a,a diethoxyacetophenone (DEAP: Rahn), a,a-di-(n-butoxy)acetophenone (Uvatone™ 8301: Upjohn); phenylglyoxolates such as methylbenzoylformate (Darocure™ MBF: Ciba); benzoin derivatives such as benzoin (Esacure™ BO: Lamberti), benzoin alkyl ethers (ethyl, isopropyl, n-butyl, iso-butyl, etc.), benzylbenzoin benzyl ethers, Anisoin; mono- and bis-Acylphosphine oxides, such as 2,4,6-trimethylbenzoyl-diphenylphosphine oxide (Lucirin™ TPO: BASF), ethyl-2,4,6-trimethylbenzoylphenylphosphinate (Lucirin™ TPO-L: BASF), bis(2,4,6-trimethylbenzoyl)-phenylphosphine oxide (Irgacure™ 819: Ciba), bis(2,6-dimethoxybenzoyl)-2,4,4-trimethyl-pentylphosphineoxide (Irgacure 1800 or 1870). Other commercially available photo-initiators are 1-[4-(phenylthio)-2-(O-benzoyloxime)]-1,2-octanedione (Irgacure OXE01), 1-[9-ethyl-6-(2-methylbenzoyl)-9H-carbazol-3-yl]-1-(O-acetyloxime)ethanone (Irgacure OXE02), 2-hydroxy-1-{4-[4-(2-hydroxy-2-methyl-propionyl)-benzyl]-phenyl}-2-methyl-propan-1-one (Irgacure127), oxy-phenyl-acetic acid 2-[2 oxo-2-phenyl-acetoxy-ethoxy]-ethyl ester (Irgacure754), oxy-phenyl-acetic-2-[2-hydroxy-ethoxy]-ethyl ester (Irgacure754), 2-(dimethylamino)-2-(4-methylbenzyl)-1-[4-(4-morpholinyl)phenyl]-1-butanone (Irgacure 379), 1-[4-[4-benzoylphenyl)thio]phenyl]-2-methyl-2-[(4-methylphenyl)sulfonyl)]-1-propanone (Esacure 1001M from Lamberti), 2,2′-bis(2-chlorophenyl)-4,4′,5,5′-tetraphenyl-1,2′-bisimidazole (Omnirad BCIM from IGM).

Examples of type II photo-initiators are benzophenone derivatives such as benzophenone (Additol™ BP: UCB), 4-hydroxybenzophenone, 3-hydroxybenzophenone, 4,4′-dihydroxybenzophenone, 2,4,6-trimethylbenzophenone, 2-methylbenzophenone, 3-methylbenzophenone, 4-methylbenzophenone, 2,5-dimethylbenzophenone, 3,4-dimethylbenzophenone, 4-(dimethylamino)benzophenone, [4-(4-methylphenylthio)phenyl]phenylmethanone, 3,3′-dimethyl-4-methoxy benzophenone, methyl-2-benzoylbenzoate, 4-phenylbenzophenone, 4,4-bis(dimethylamino)benzophenone, 4,4-bis(diethylamino)benzophenone, 4,4-bis(ethylmethylamino)benzophenone, 4-benzoyl-N,N,N-trimethylbenzenemethanaminium chloride, 2-hydroxy-3-(4-benzoylphenoxy)-N,N,N-trimethyl-1-propanamium chloride, 4-(13-Acryloyl-1,4,7,10,13-pentaoxatridecyl)benzophenone (Uvecryl™ P36: UCB), 4-benzoyl-N,N-dimethyl-N-[2-(1-oxo-2-propenyl)oy]ethylbenzenemethanaminium chloride, 4-benzoyl-4′-methyldiphenyl sulphide, anthraquinone, ethylanthraquinone, anthraquinone-2-sulfonic acid sodium salt, dibenzosuberenone; acetophenone derivatives such as acetophenone, 4′-phenoxyacetophenone, 4′-hydroxyacetophenone, 3′-hydroxyacetophenone, 3′-ethoxyacetophenone; thioxanthenone derivatives such as thioxanthenone, 2-chlorothioxanthenone, 4-chlorothioxanthenone, 2-isopropylthioxanthenone, 4-isopropylthioxanthenone, 2,4-dimethylthioxanthenone, 2,4-diethylthioxanthenone, 2-hydroxy-3-(3,4-dimethyl-9-oxo-9H-thioxanthon-2-yloxy)-N,N,N-trimethyl-1-propanaminium chloride (Kayacure™ QTX: Nippon Kayaku); diones such as benzyl, camphorquinone, 4,4′-dimethylbenzyl, phenanthrenequinone, phenylpropanedione; dimethylanilines such as 4,4′,4″-methylidyne-tris(N,N-dimethylaniline) (Omnirad™ LCV from IGM); imidazole derivatives such as 2,2′-bis(2-chlorophenyl)-4,4′,5,5′-tetraphenyl-1,2′-bisimidazole; titanocenes such as bis(eta-5-2,4-cyclopentadiene-1-yl)-bis-[2,6-difluoro-3-1H-pyrrol-1-yl]phenyl]titanium (Irgacure™ 784: Ciba); iodonium salt such as iodonium, (4-methylphenyl)-[4-(2-methylpropyl-phenyl)-hexafluorophosphate (1-). Combinations of two or more photo-initiators may also be used.

When acrylates, diacrylates, triacrylates or multifunctional acrylates constitute the cross-linkable group, type I photo-initiators are preferred. Especially alpha-hydroxyalkylphenones, such as 2-hydroxy-2-methyl-1-phenyl propan-1-one, 2-hydroxy-2-methyl-1-(4-tert-butyl-) phenylpropan-1-one, 2-hydroxy-[4′-(2-hydroxypropoxy)phenyl]-2-methylpropan-1-one, 2-hydroxy-1-[4-(2-hydroxyethoxy)phenyl]-2-methyl propan-1-one, 1-hydroxycyclohexylphenylketone and oligo[2-hydroxy-2-methyl-1-{4-(1-methylvinyl)phenyl}propanone], alpha-aminoalkylphenones, alpha-sulfonylalkylphenones and acylphosphine oxides such as 2,4,6-trimethylbenzoyl-diphenylphosphine oxide, ethyl-2,4,6-trimethylbenzoylphenylphosphinate and bis(2,4,6-trimethylbenzoyl)-phenylphosphine oxide, are preferred.

The coating composition of the invention can be used for coating any shape or type of surface. The material of which a surface is coated may be a flat, dense or complex shaped body. It may have a porous, beaded or meshed ingrowth surface, all depending on the purpose of the body.

As set forth above, the coating may be applied to a surface by any means known in the art, such as brushing, spraying, wiping, dipping, extruding or injecting the coating onto said surface.

A second aspect of the invention provides a coated surface obtainable by a method as described in the first aspect of the invention. Preferably the coated surface is a medical device as described in the first aspect of the invention. It is particularly preferred that the coated surface is a vascular stent, a surgical implant or a catheter.

A third aspect of the invention provides a liquid composition comprising a recombinant gelatin, an antimicrobial agent and N-ethyl-N-3-dimethylaminopropyl-carbodiimide. In the third aspect of the invention the recombinant gelatin and antimicrobial agent are as described and preferred in the first aspect of the invention. In the third aspect of the invention the term “liquid composition” should be understood to refer to the gelatin solution prior to cross linker induced gelling

A fourth aspect of the invention provides a liquid composition comprising a recombinant gelatin, an antimicrobial agent and a photoinitiator. In the fourth aspect of the invention the recombinant gelatin, antimicrobial agent and photoinitiator are as described and preferred in the first aspect of the invention.

The invention is explained in more detail in the following, non-limiting examples.

### EXAMPLES

### 1. Coating of Natural Gelatin

10% w/w and 20% w/w of limed bone gelatin (PBLJ) or pharmaceutical degree hydrolyzed pigskin gelatin (bone plugs, pigskin) was dissolved in water at 40° C. The pH of the PBLJ solutions was adjusted with NaOH to ˜7 and the pH of pigskin gelatin was adjusted to ˜6.

Crosslinker N-ethyl-N-3-dimethylaminopropyl-carbodiimide (EDC, Degussa) was prepared just before use. Based on literature the following assumption was made for this study: 10 gram of gelatin contains 4 mmol lysines. 25% w/w EDC was added in various amounts to the gelatin solutions. The amount was calculated as the EDC/lysine ratio (mol/mol). EDC was added slowly to the gelatin solutions while stirring. To prevent gelling, the gelatin was immediately coated on the pre-treated glass microscope (chitosan, silane or lysine base layer) with help of a hand coater bar resulting in 12, 100 or 300 μm thick layers. The coating was dried overnight.

### 2. Coating of Slides with Recombinant Gelatin

Recombinant gelatins P4 (Werten et al. (2001) Protein Engineering, vol. 14 (6):447-454), and the ERGD recombinant gelatin monomer and pentamer designated CBE1 and CBE5 respectively, as described in international patent application WO2008103042, were used in this study. For CBE1 and CBE5, first a pre-layer of 12 μm of recombinant gelatin (without EDC) was applied onto a 12 μm chitosan coated glass slide and dried for ˜2 hours. For P4 silane coated slides (Sigma) were used. CBE gelatins were prepared in a 10% w/w solution in water at room temperature.

For coating and crosslinking, 5 μl of 25% EDC was added to 400 μl 10% CBE1 or CBE5 in a 1.5 ml tube and mixed immediately. This solution was transferred to the gelatin/chitosan coated glass described above and coated with a hand coater. P4 was prepared as a 25% w/w solution in water at room temperature. 60 μl of 25% EDC was added to 400 μl 25% P4, mixed, and coated on silane coated glass slides (Sigma). All coatings were dried overnight. The crosslinking reaction was verified by checking the hardening of the excess of gelatin in a 1.5 ml tube.

### 3. Beta-Lactam Eluting Coating

Ampicilline was purchased from Sigma. A stock solution of 50 mg/ml was prepared by dissolving ampicilline in water (store at −20° C.). Ampicilline was either added immediately to recombinant gelatin together with EDC (pre-crosslinking) or was applied after hardening of recombinant gelatin (post-crosslinking). In the pre-hardening method, various amounts of ampicilline form the stock solution were diluted in EDC-gelatin, ranging from 50 to 5000 μg/ml. To achieve a 100 μm thick coating, 400 μl EDC-gelatin/ampicilline mixture was used. In the post-hardening method, the stock solution of ampicilline was diluted 1000 to 100 times in water (50-500 μg/ml ampicilline). Of the diluted ampicilline solution 2.5 ml was incubated on the gelatin for 10 minutes, after which the excess ampicilline solution was removed and the coating was dried. The slides were stored at 4° C. to preserve the activity of ampicilline.

### 4. Strains and Growth Conditions

The strains Staphylococcus epidermidis GB9/6, isolated from an explanted silicone rubber voice prosthesis and Pseudomonas aeruginosa ATCC 10145-U were used.

The strains S. epidermidis GB9/6 and P. aeruginosa ATCC 10145-U were incubated on a blood agar plate at 37° C. from frozen stock (−80° C.). A pre-culture was made in 10 ml tryptone soya broth (TSB) overnight at 37° C. Then the cultures were grown from the pre-culture in 200 ml TSB overnight at 37° C. Bacteria were harvested by centrifugation (5 minutes at 5000 g, 10° C.), washed twice with phosphate-buffered saline (PBS; 8.76 g/L NaCl, 10 mM potassium phosphate, pH 7.0) and resuspended into PBS at a density of 3.108 cells/mL as determined in a BürkerTürk counting chamber.

### 5. Parallel-Plate Flow Chamber and Image Analysis

Parallel plate flow chambers (dimension: l*w*h=17.5*1.7*0.075 cm), were used to quantify the amount of initial adhering bacteria to gelatin coatings on the bottom plate.

### Experimental Design and Data Analysis

Four parallel plate flow chambers were placed parallel to each other. Before starting each experiment, all tubes and the flow chambers were filled with PBS, while care was taken to remove air bubbles from the system. Flasks containing microbial suspension and PBS were connected to the flow chambers. The flasks were positioned at the same height with respect to the chamber, so the fluid proceeded through the flow chamber under the influence of hydrostatic pressure at a shear rate of 3.33 s-1. First the system was rinsed with PBS for 20 minutes. Then, the microbial suspension was flowed through the system for 60 minutes. After that, the system was again rinsed with PBS for 10 minutes. Images were collected at the end of the experiment. Before the experiment started, bacteria from the suspension were stained with a viability staining (Live/Dead Baclight bacterial viability kit: green-fluorescent bacteria are alive, red-fluorescent bacteria are dead) for 15 minutes in the dark. At the end the flow chamber was opened and the adhered bacteria were also stained with live/dead staining. The amount of viable bacteria was determined with a fluorescence microscope.

### Results:

The amount of viable bacteria attached to the coating

| | | | | | | CBE5/50 mg/ |
|---|---|---|---|---|---|---|
| | Uncoated | PBLJ | P4 | CBE | CBE5 | ml Amp |
| P. aeruginosa | +++ | ++ | + | + | + | +/− |
| S. epidermidis | +++ | ++ | + | + | + | +/− |

1. A method for applying a coating, comprising recombinant gelatin and an antimicrobial agent, to a surface comprising the steps of:
a) mixing the recombinant gelatin and the antimicrobial agent at a temperature of between 0° C. and 40° C. to obtain a mixture; and
b) crosslinking the mixture at a temperature of between 0° C. and 40° C.

2. A method according to claim 1 wherein the recombinant gelatin comprises non-gelling recombinant gelatin.

3. A method according to claim 1, wherein the recombinant gelatin comprises non-hydroxylated gelatin.

4. A method according to claim 1, wherein the recombinant gelatin comprises recombinant gelatin that is substantially free of helix formation.

5. A method according to claim 1, wherein the antimicrobial agent is a thermolabile antimicrobial agent.

6. A method according to claim 5, wherein the thermolabile antimicrobial agent is a thermolabile aminoglycoside or a thermolabile beta-lactam antibiotic.

7. A method according to claim 1, wherein in step a) the mixture of recombinant gelatin and the antimicrobial agent further comprises a photo-initiator.

8. A method according to claim 1 wherein the coating may be applied onto the surface in-between steps a) and b), or after step b).

9. A method according to claim 1 wherein step a) is achieved by coating the surface with the recombinant gelatin, followed by contacting the surface with a solution comprising the antimicrobial agent, whereby the antimicrobial agent is incorporated in the recombinant gelatin.

10. A method according to claim 1, wherein the coating is applied to the surface of a medical device.

11. A method according to claim 10 wherein the medical device is selected from the group consisting of a vascular stent, a surgical implant and a catheter.

12. A coated surface obtainable by a method as described in claim 1.

13. A medical device obtainable by a method as described in claim 10.

14. A vascular stent, a surgical implant or a catheter obtainable by a method as described in claim 11.

15. A liquid composition comprising a recombinant gelatin, an antimicrobial agent and N-ethyl-N-3-dimethylaminopropyl-carbodiimide.

16. A liquid composition comprising a recombinant gelatin, an antimicrobial agent and a photoinitiator.
